(19) United States
(12) Patent Application Publication
(10) Pub. No.: US 2013/0105108 A1
(43) Pub. Date: May 2, 2013

(54) Heat Removal From Substrates In Vacuum

(71) Applicant: KLA-TENCOR CORPORATION, Milpitas, CA (US)

(72) Inventors: Marek Zywno, San Jose, CA (US); Layton Carter Hale, Castro Valley, CA (US)

(73) Assignee: KLA-TENCOR CORPORATION, Milpitas, CA (US)

(21) Appl. No.: 13/661,146

(22) Filed: Oct. 26, 2012

Related U.S. Application Data
(60) Provisional application No. 61/552,088, filed on Oct. 27, 2011.

(51) Int. Cl. G05D 23/19; F25B 29/00

(52) U.S. Cl. CPC G05D 23/19; F25B 29/00
USPC 165/11.1; 165/64

(57) ABSTRACT

Systems and methods to precisely balance the amount of heat removed from a specimen with the amount of heat generated during processing are presented. In some embodiments, the heat introduced into the specimen is rapidly removed by a temperature controlled cooling element via radiative heat transfer. In some embodiments, a heating element is disposed between the specimen and the cooling element. The heating element is controlled to precisely balance the amount of heat removed from the specimen with the amount of heat generated. A control signal is generated based on the amount of process energy known apriori. The control signal may also be based on an indication of a temperature of the specimen. In some embodiments, an adjustable aperture is employed to change the surface area of the cooling element exposed to the specimen, and thus control the amount of heat absorbed from the specimen by the cooling element.

### CROSS REFERENCE TO RELATED APPLICATION

The present application for patent claims priority under 35 U.S.C. §119 from U.S. provisional patent application Ser. No. 61/552,088, entitled “Radiative Heat Removal From Substrates In Vacuum,” filed Oct. 27, 2011, the subject matter of which is incorporated herein by reference.

### TECHNICAL FIELD

The described embodiments relate to systems for wafer processing, and more particularly to processes performed in vacuum.

### BACKGROUND INFORMATION

Semiconductor devices such as logic and memory devices are typically fabricated by a sequence of processing steps applied to a specimen. The various features and multiple structural levels of the semiconductor devices are formed by these processing steps. For example, lithography among others is one semiconductor fabrication process that involves generating a pattern on a semiconductor wafer. Additional examples of semiconductor fabrication processes include, but are not limited to, chemical-mechanical polishing, etch, deposition, and ion implantation. Multiple semiconductor devices may be fabricated on a single semiconductor wafer and then separated into individual semiconductor devices.

A lithographic process, as described above, is performed to selectively remove portions of a resist material overlaying the surface of a wafer, thereby exposing underlying areas of the specimen on which the resist is formed for selective processing such as etching, material deposition, implantation, and the like. Therefore, in many instances, the performance of the lithography process largely determines the characteristics (e.g., dimensions) of the structures formed on the specimen. Consequently, the trend in lithography is to design systems and components (e.g., resist materials) that are capable of forming patterns having ever smaller dimensions. A large part of the effort in developing advanced lithography systems involves the design and development of exposure tools that expose the resist in a predetermined pattern. In particular, the resolution capability of the lithography tools is one primary driver of lithography research and development.

Traditional lithographic processes utilize electromagnetic energy in the form of ultraviolet light for selective exposure of the resist. As an alternative to electromagnetic energy (including x-rays and extreme ultraviolet radiation), charged particle beams have been used for high resolution lithographic resist exposure. In particular, electron beams have been used since the low mass of electrons allows relatively accurate control of an electron beam at relatively low power and relatively high speed. Electron beam lithographic systems may be categorized as electron-beam direct write (EBDW) lithography systems and electron beam projection lithography systems.

In EBDW lithography, the specimen is sequentially exposed by means of a focused electron beam. Such a lithography tool may be configured to scan the electron beam over the whole specimen in the form of lines, and the desired structure is written on the specimen by corresponding blanking of the beam. Alternatively, such a lithography tool may be configured to guide the focused electron beam over the regions of the resist to be exposed in a vector scan method. The beam spot may be shaped by a diaphragm. EBDW has relatively high flexibility since the circuit geometries are stored in a computer and can be optionally varied. Furthermore, very high resolutions can be attained by electron beam writing since electron foci with small diameters may be attained with electron-optical imaging systems. However, direct writing is disadvantageous in that the process is very time-consuming due to the sequential, point-wise writing. EBDW is therefore at present mainly used for the production of the masks required in projection lithography.

Electron beam projection lithography, analogous to optical lithography, a larger portion of a mask is illuminated simultaneously and is imaged on a reduced scale on a wafer by projection optics. Since a whole field is imaged simultaneously in electron beam projection lithography, the attainable throughputs can be markedly higher in comparison with electron beam direct writers.

Electron beam systems are becoming increasingly relied upon not only in lithography, but also in the inspection of devices formed in semiconductor fabrication. For example, as the dimensions of semiconductor devices continue to shrink with advances in semiconductor materials and processes, the ability to detect defects having corresponding decreasing dimensions has become increasingly important in the successful fabrication of advanced semiconductor devices. Therefore, significant research continues to focus on increasing the resolution capability of tools that are used to examine microscopic features and defects. Microscopes that utilize electron beams to examine devices may be used to detect defects and investigate feature sizes as small as, e.g., a few nanometers. Therefore, tools that utilize electron beams to inspect semiconductor devices are increasingly becoming relied upon in semiconductor fabrication processes. For example, in recent years, scanning electron microscopy has become increasingly popular for the inspection of semiconductor devices.

Many semiconductor processing steps, particularly high throughput, electron beam lithography and inspection systems, introduce a significant amount of heat into the specimen. For example, in various lithographic and inspection systems, energy in the form of electromagnetic radiation or kinetic energy (e.g., moving electrons, moving ions, etc.) is directed to the surface of a specimen. The interaction of the incoming energy with the specimen materials generates heat at the specimen surface in the exposed area. A change in temperature of the specimen material causes the specimen to change dimension (i.e., undergo thermal expansion). If the heating is contained locally, it results in local distortion of the specimen at the surface or in the bulk of the material. However, due to thermal conductivity of the specimen, heat dissipates through the material over time. This causes changes of dimension of the entire specimen.

In some semiconductor processes, dimensional accuracy is not critical and the resulting changes in dimension are tolerable. In some other examples, dimensional accuracy may be critical, but the process involves only moderate amounts of heat generation that is rapidly transferred away from the specimen. Heat may be transferred away from the wafer to the environment by conduction and convection, (e.g., cooling of specimen by air flow or water flow). For example, in immersion lithography, cooling water is passed over the surface of the specimen to carry away the heat generated by the lithographic process. The resulting surface distortion and specimen distortion is minimized relative to the overall dimensional accuracy of the process.

However, several proposed semiconductor process technologies involve a significant amount of heat generation at the exposure location, in particular, several lithographic processes currently under development. Furthermore, several of these processes (including electron beam based systems) must be conducted in vacuum. This effectively precludes many of the conventional options for heat removal.

As lithographic and inspection systems with processes conducted in vacuum are pressed to higher accuracies, heat removal becomes a limiting factor in maintaining placement accuracy of features on a specimen. Thus, improved methods and systems for rapid removal of heat from specimens under process, particularly in vacuum, are desired.

### SUMMARY

Process energy projected onto a specimen generates unwanted heat and thermally induced distortions unless the heat is removed. This is particularly challenging in a deep vacuum environment. Systems and methods to precisely balance the amount of heat removed from a specimen with the amount of heat generated during processing are presented.

In one aspect, a semiconductor processing system implements heat control functionality that precisely balances the amount of heat introduced by exposure of a specimen to process energy to an amount of heat removed from the specimen by radiative heat transfer. During processing, an amount of heat is generated by an interaction between the specimen and the amount of energy projected onto the specimen surface. The heat introduced into the specimen is rapidly removed by a cooling element. A heating element disposed between the specimen and the cooling element is controlled to precisely regulate the amount heat removed from the specimen. Control of the heating element is based on the dosage of energy known apriori and may also be based on sensor feedback indicative of the temperature of the specimen.

In some embodiments, a heat balancing controller adjusts a temperature of at least one heating element such that an amount of heat removed from the specimen is approximately equal to the amount of heat introduced to the specimen by incident process energy. In some examples, the controller generates a signal to control the heating element based on the energy dosage to the specimen known apriori. In some examples, the controller generates a signal to control the heating element based on an indication of the temperature of the specimen. The control objective is to control the heat removed from the specimen such that the difference between the temperature of specimen and reference value is zero. In this manner, the difference between the heat added to specimen by process energy and the net amount of heat removed from the specimen is driven toward zero.

In another aspect, a cooling element is spaced apart from a specimen and located on the same side of specimen upon which process energy is projected. The temperature of the cooling element is directly controlled to precisely regulate the amount heat removed from the specimen. Control of the cooling element is based on the dosage of process energy. In some examples, control of the cooling element is also based on sensor feedback indicative of the temperature of the specimen.

In yet another aspect, an array of cooling elements is mounted below the backside of the specimen and an array of temperature sensors is mounted between the array of cooling elements and the specimen. In one example, the array of cooling elements is an array of individually addressable and controllable thermoelectric coolers. The array of temperature sensors provides a measurement of the temperature field on the back side of specimen. A controller generates a control signal based on the difference between the temperature field measured by the array of temperature sensors and a desired temperature field. In response, the array of cooling elements selectively absorbs heat from the backside of specimen at the desired locations.

In yet another aspect, the amount of surface area of the cooling element exposed to the specimen is controlled by an adjustable aperture. In this manner, the amount of heat removed from the specimen is controlled by adjusting the size of the aperture. In some embodiments, the adjustable aperture is located between the specimen and the cooling plate and includes a thin sheet member akin to a sliding door or a camera shutter that is moved by an actuator (e.g., a piezo actuator) to selectively increase or decrease the area of the cooling element exposed to the specimen. In some embodiments, the shape of adjustable aperture is designed to approximately match the shape of a heat plume across the specimen. In this manner, the spatial distribution of heat absorbed from specimen approximately matches the spatial distribution of heat introduced into specimen. The area of the cooling element exposed to the specimen is adjusted to keep the amount of heat absorbed by the cooling element closely matched to the heat introduced to specimen by incident process energy.

In some examples, a controller generates a control signal that is transmitted to the adjustable aperture to change the area of the cooling element exposed to the specimen based on the dosage of incident process energy known apriori and may also be based on sensor feedback indicative of the temperature of the specimen.

The foregoing is a summary and thus contains, by necessity, simplifications, generalizations and omissions of detail; consequently, those skilled in the art will appreciate that the summary is illustrative only and is not limiting in any way. Other aspects, inventive features, and advantages of the devices and/or processes described herein will become apparent in the non-limiting detailed description set forth herein.

### BRIEF DESCRIPTION OF THE DRAWINGS

FIG. 1 is a simplified schematic view of one embodiment of a semiconductor processing system 100 that may be used to perform specimen cooling methods described herein.

FIG. 2 is a diagram illustrative of a controllable heating element that may be used to precisely balance the amount of heat removed from a specimen with the amount of heat introduced into the specimen by process energy in one embodiment.

FIG. 3 is a diagram illustrative of a controllable heating element that may be used to precisely balance the amount of heat removed from a specimen with the amount of heat introduced into the specimen by process energy in another embodiment.

FIG. 4 is a diagram illustrative of a controllable cooling element that may be used to precisely balance the amount of heat removed from a specimen with the amount of heat introduced into the specimen by process energy in one embodiment.

FIG. 5 is a diagram illustrative of an adjustable aperture that may be used to control the amount of heat removed from a specimen.

FIG. 6 is a diagram illustrative of sensors mounted to a chuck that may be used to detect a temperature of a specimen under process.

FIG. 7. is a diagram illustrative of a sensor that may be used to detect a temperature of specimen in one embodiment.

FIG. 8 is a flowchart illustrative of one exemplary method 400 of balancing the amount of heat removed from a specimen with the amount of heat introduced into the specimen by process energy.

FIG. 9 is a simplified schematic view of another embodiment of a semiconductor processing system 100 that may be used to perform specimen cooling methods described herein.

FIG. 10 is a diagram illustrative of a controllable cooling element that may be used to precisely balance the amount of heat removed from a specimen with the amount of heat introduced into the specimen by process energy in another embodiment.

### DETAILED DESCRIPTION

Reference will now be made in detail to background examples and some embodiments of the invention, examples of which are illustrated in the accompanying drawings.

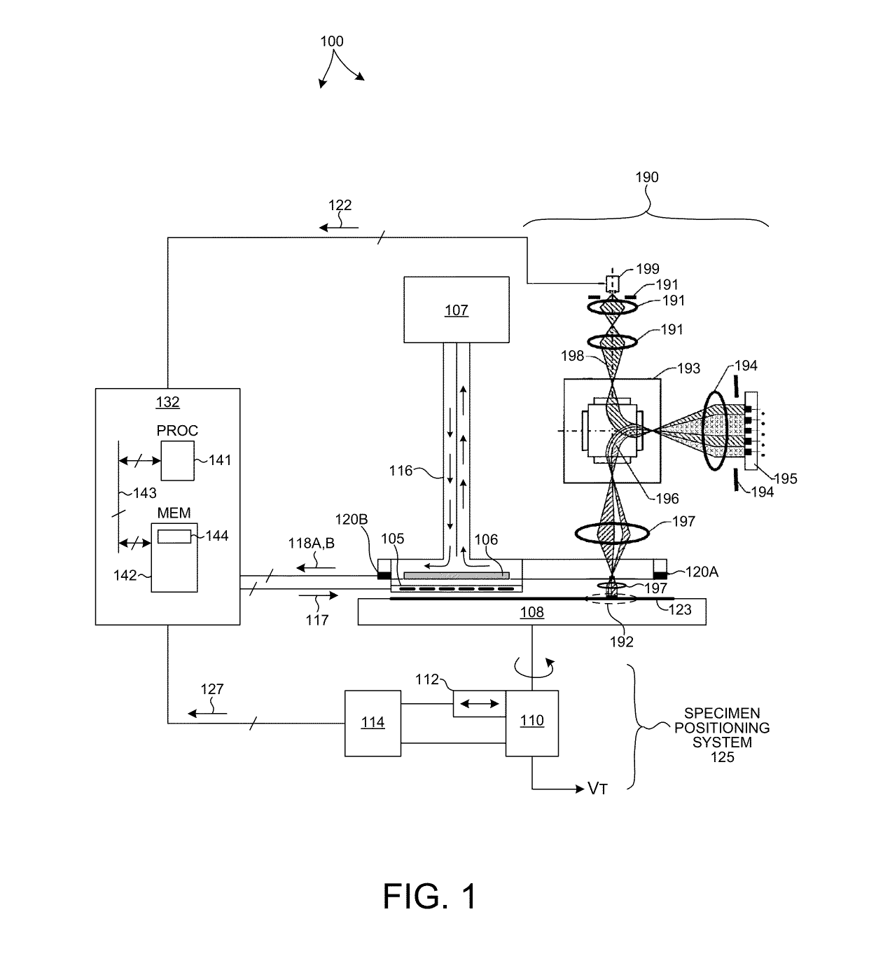

FIG. 1 is a simplified schematic view of one embodiment of a semiconductor processing system 100 that may be used to perform specimen cooling methods described herein. In the illustrated embodiment electrons are projected onto a specimen 123. The system 100 includes specimen positioning system 125 that is configured to support and move specimen 123 during projection of electrons onto the specimen. The system 100 also includes projection subsystem 190. Projection subsystem 190 is configured to project an electron beam onto specimen 123 while specimen positioning system 125 is moving specimen 123. Projection subsystem 190 includes electron source 199, illumination electron-optics 191, magnetic prism 193, objective electron-optics 194, dynamic pattern generator (DPG) 195, and projection electron-optics 197.

Electron source 199 may be configured to supply a relatively large current at relatively low brightness (current per unit area per solid angle) over a relatively large area. The large current allows the subsystem to have a high throughput rate. In some embodiments, the material of source 199 is configured to provide a brightness of about 10⁴ A/cm²sr or about 10⁵ A/cm²sr (Amperes per cm² steradian) at 50,000 electron volts (eV) beam energy. One example of an appropriate electron source is a LaB₆ source that has a brightness of about 10⁶ A/cm²sr at 50,000 eV beam energy. A different example of an appropriate electron source is a tungsten dispenser emitter, which typically has a brightness of about 10⁵ A/cm²sr when operating at 50,000 eV. Additional examples of an appropriate electron source may include a tungsten Schottky cathode and heated refractory metal disks (i.e., tantalum, Ta). In some embodiments, electron source 199 is a large area of electrode from which electrons are extracted by an electrostatic lens.

Electron source 199 may also be configured to have a relatively low energy spread. The projection subsystem 190 may be configured to control the energy of the electrons so that their turning points (i.e., the distance from DPG 195 at which they reflect) are relatively constant, for example, to within about 100 nm. To keep the turning points to within about 100 nm, electron source 199 preferably has an energy spread of no greater than about 0.5 eV. LaB₆ emitters have typical energy spreads of about 0.5 eV to about 1 eV, and tungsten dispenser emitters have typical energy spreads of about 0.2 eV to about 0.5 eV. In one embodiment, electron source 199 includes a LaB₆ source or a tungsten Schottky emitter that is operated at a few hundred degrees Centigrade below its normal operating temperature to reduce the energy spread of the emitted electrons. However, cooler operating temperatures can destabilize source 199, for example, due to impurities settling on the source surface thereby diminishing its reliability and stability. Therefore, the source material may be selected to be a material in which impurities are unlikely to migrate to the surface thereby reducing choking off of the emission by the impurities. Moreover, the vacuum on the projection subsystem may be improved to overcome the impurity problem. Conventional lithography systems operate at a vacuum of 10⁻⁶ Torr. A scanning electron microscope (SEM) with a LaB₆ source typically operates at 10⁻⁷ Torr. A SEM with a Schottky emitter typically operates at 10⁻⁹ Torr or lower in the gun region. In one configuration, the projection subsystem 190 operates with a gun region vacuum of 10⁻⁹ Torr or lower to protect the stability of the electron source.

In some embodiments, the electron source 199 is a large area cathode. A wide beam of electrons is extracted from the cathode and accelerated through the electron optics 191, directed by a prism or Wien filter towards the array of pixels of the Dynamic Pattern Generator (DPG) 195. The DPG 195 is at a potential very near to that of the cathode, so the electrons slow down in the vicinity of the DPG. The pixels of the DPG are biased positively or negatively relative to the beam energy. The pixels of DPG form a rectangular array, having a width in the scanning direction sufficient to form an appropriate gray level, and a height corresponding to the height of the swath exposed on the substrate 123. Electrons illuminating positively biased pixels get absorbed, and electrons illuminating negatively biased pixels are reflected. The reflecting pixels form an image to be projected onto the wafer. This image is passed across the array in the scanning direction synchronously with the specimen 123 on positioning system 125 in such a way, that the image moving across the DPG pixels is stationary on the specimen 123. Any point of the specimen 123, therefore accumulates charge obtained from the entire row of pixels of the DPG in the scanning direction. By varying the ratio of reflecting and absorbing pixels of the DPG an appropriate dose is generated, corresponding to an appropriate gray level exposure.

Illumination electron-optics 191 are configured to receive and collimate the electron beam from electron source 199. Illumination optics 191 allow adjustment of the current illuminating DPG 195 and therefore may be used to determine the electron dose used to expose specimen 123. Illumination optics 191 may include an arrangement of magnetic and/or electrostatic lenses configured to focus electrons from electron source 199 thereby generating incident electron beam 198.

Magnetic prism 193 is configured to receive incident electron beam 198 from illumination optics 191. When the incident beam traverses the magnetic fields of the prism, a force proportional to the magnetic field strengths acts on the electrons in a direction perpendicular to their trajectory (i.e., perpendicular to their velocity vectors). In particular, the trajectory of incident beam 198 is bent toward objective electron-optics 194 and DPG 195. In some embodiments, magnetic prism 193 is configured with a non-uniform magnetic field to provide stigmatic focusing, for example, as disclosed in U.S. Pat. No. 6,878,937 to Mankos, which is incorporated by reference as if fully set forth herein. A uniform magnetic field provides astigmatic focusing where focusing occurs in only one direction (e.g., so as to image a point as a line). In contrast, magnetic prism 193 may be configured to focus in both directions (so as to image a point as a point) because prism 193 is also used for imaging. The stigmatic focusing of prism 193 may be implemented by dividing it into smaller sub-regions with different but uniform magnetic fields. Furthermore, the lens elements in prism 193 may have a relatively longer length and width to provide a low distortion image over a large field size. However, increasing the length of prism 193 involves a trade-off of more electron-electron interactions, which may cause more blur. Therefore, the reduced image distortion may be balanced against the increased blur when increasing the prism length.

Below magnetic prism 193, the electron-optical components of the objective optics are common to the illumination and projection electron-optics. Objective optics 194 may include an objective lens and one or more transfer lenses (not shown). The objective optics are configured to receive the incident beam from prism 193 and to decelerate and focus the incident electrons as they approach DPG 195. The objective optics are preferably configured (in cooperation with electron source 199, illumination optics 191, and prism 193) as an immersion cathode lens and are utilized to deliver an effectively uniform current density (i.e., a relatively homogenous flood beam) over a large area in a plane above the surface of DPG 195. In some embodiments, the objective lens may be configured to operate with a system operating voltage of about 50,000-100,000 eV. Other operating voltages may be used in other configurations.

DPG 195 includes an array of pixels. Each pixel may include a metal contact to which a voltage level is controllably applied. DPG 195 may be coupled to a high voltage source (not shown) and a parallel data path (not shown). The parallel data path may be configured to carry control signals to DPG 195 for controlling the voltage on each pixel (so that it either absorbs or reflects electrons). The control signals may be adjusted so that the pattern moves electronically across the DPG pixel array in a manner that is substantially the same as the way signals move through a shift register and at a rate so as to match the movement of the specimen 123. In this manner, each exposed point on the specimen may receive reflected electrons from an entire column (or row) of DPG pixels, integrated over time. In one configuration, DPG 195 is configured to resemble a static random access memory (SRAM) circuit.

The extraction part of the objective lens provides an extraction field in front of DPG 195. As reflected electrons 196 leave DPG 195, the objective optics are configured to accelerate reflected electrons 196 toward their second pass through prism 193. Prism 193 is configured to receive reflected electrons 196 from the transfer lens and to bend the trajectories of the reflected electrons toward projection optics 197.

Projection electron-optics 197 reside between prism 193 and specimen 123. Projection optics 197 are configured to focus the electron beam and demagnify the beam onto specimen 123 over an area of electron beam incidence 192. The demagnification may range, for example, from about one times demagnification to about one hundred times demagnification (i.e., about one times magnification to about 0.01 times magnification). The blur and distortion of the electrons due to projection optics 197 is preferably a fraction of the pixel size. In one configuration, the pixel size on the wafer may be, for example, 16 nanometers. In such a case, projection optics 197 preferably have aberrations and distortions of less than about 5 nm to about 10 nm. In this manner, energy is transferred to specimen 123 over an area of electron beam incidence 192.

The aforementioned embodiments of a maskless reflection electron beam projection lithography system are presented by way of non-limiting example. In some other embodiments, projection subsystem 190 is configured as a Wien column employing a Wien combiner in lieu of magnetic prism 193 and simplified illumination and projection optics. Other configurations may also be contemplated within the scope of this disclosure.

As illustrated in FIG. 1, the system 100 is configured as a lithography system. In particular, the system is configured as a maskless reflection electron beam projection lithography system. In this manner, the system may be configured to expose a resist formed on a specimen in a predetermined pattern. The specimen may be a wafer or a reticle. Therefore, the system may be used in wafer and reticle manufacturing.

In an alternative embodiment, the system shown in FIG. 1 is configured as an inspection system. In such an embodiment, the projection subsystem may be configured as shown in FIG. 1, and various parameters of the projection subsystem may be selected for inspection. For example, the system configurations described above may be altered such that the electrons are provided to the specimen at a lower current and lower brightness than described above. These parameters may be selected such that inspection can be performed with relatively high sensitivity and relatively high throughput while avoiding changes in the specimen due to the electron beam. Parameters such as the current and brightness may be selected as described above (e.g., by selecting an appropriate electron source and/or controlling the dose of the electrons projected onto the specimen using illumination electron optics 191). The system may be configured to inspect the specimens described above such as wafers and reticles. In this manner, the system may be configured as a wafer inspection system or a reticle inspection system. Examples of electron beam based inspection systems are illustrated in U.S. Pat. No. 6,555,830 to Mankos et al., U.S. Pat. No. 6,759,654 to Mankos et al., and U.S. Pat. No. 6,878,937 to Mankos, which are incorporated by reference as if fully set forth herein.

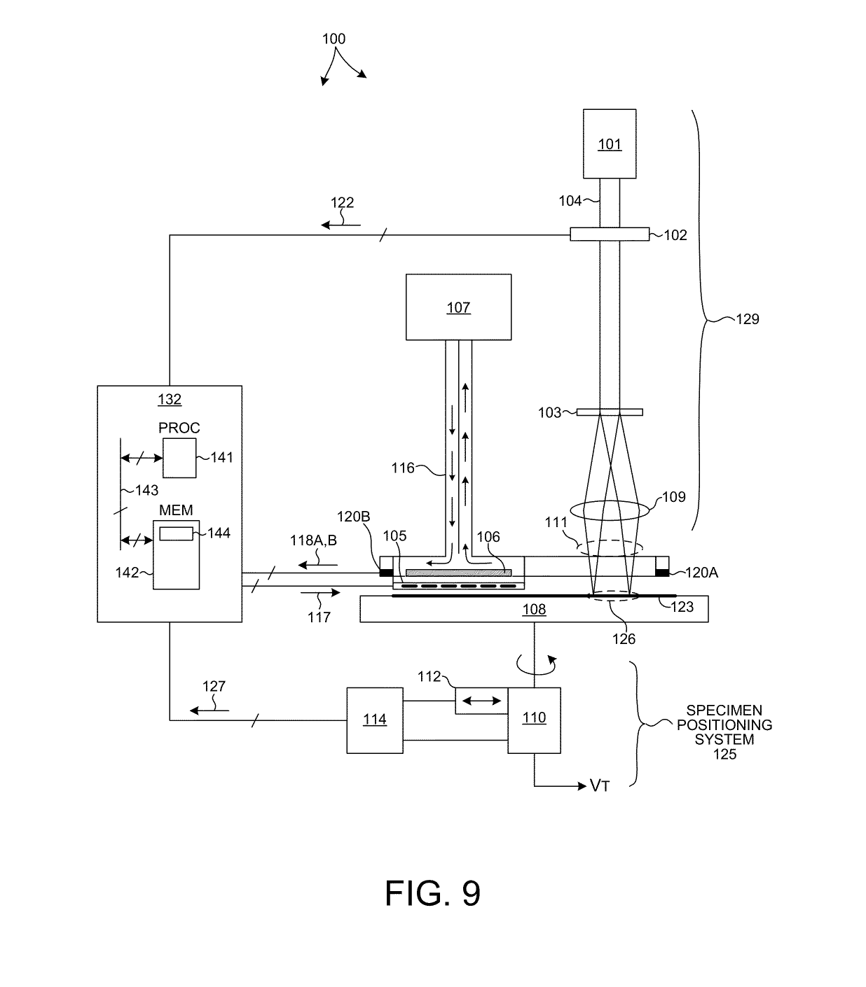

In some other embodiments, energy is transferred to specimen 123 by electromagnetic radiation, rather than electrons. FIG. 9 is a simplified schematic view of another embodiment of a semiconductor processing system 100 that may be used to perform specimen cooling methods described herein. In the illustrated embodiment, electromagnetic radiation is projected onto a specimen 123. For simplification, some optical components of the system have been omitted. By way of example, folding mirrors, polarizers, beam forming optics, additional light sources, additional collectors, and detectors may also be included. All such variations are within the scope of the invention described herein. In one example, the system described herein may be used for patterning specimens. In another example, the system described herein may be used for inspecting specimens.

As illustrated in FIG. 9, a specimen 123 is illuminated by a normal incidence beam 104 generated by one or more illumination sources 101. Alternatively, the illumination subsystem may be configured to direct the beam of light to the specimen at an oblique angle of incidence. In some embodiments, system 100 may be configured to direct multiple beams of light to the specimen such as an oblique incidence beam of light and a normal incidence beam of light. The multiple beams of light may be directed to the specimen substantially simultaneously or sequentially.

Illumination source 101 may include, by way of example, a laser, a diode laser, a helium neon laser, an argon laser, a solid state laser, a diode pumped solid state (DPSS) laser, a xenon arc lamp, a gas discharging lamp, a laser sustained plasma, a discharge based plasma, an LED array, or an incandescent lamp. The light source may be configured to emit near monochromatic light or broadband light. In general, the illumination projection subsystem 129 is configured to direct light having a relatively narrow wavelength band to the specimen (e.g., nearly monochromatic light or light having a wavelength range of less than about 20 nm, less than about 10 nm, less than about 5 nm, or even less than about 2 nm). Therefore, if the light source is a broadband light source, the illumination projection subsystem 129 may also include one or more spectral filters that may limit the wavelength of the light directed to the specimen. The one or more spectral filters may be bandpass filters and/or edge filters and/or notch filters.

System 100 may include a spot array generator 103 that generates a desired beamlet array 111 from the output of illumination source 101. This “generated beamlet array” is directed to the specimen surface. To eliminate confusion, the light that reaches the surface of the specimen is referred to herein as the “incident beamlet array” or the “incident spot array.” The “incident spot array” may differ from the “generated beamlet array” in one or more ways, including polarization, intensity, size and shape of the spot, etc. In one embodiment, spot array generator 103 includes a diffractive optical element to generate the desired number of spots, size of each spot, and spacing between spots. The size, number, and spacing between spots may be determined by a user or may be automatically generated by system 100. The beamlet array is directed to an objective lens 109. Objective lens 109 focuses the beamlet array 111 onto a specimen 123 to form incident spot area 126. Incident spot area 126 is defined (i.e., shaped and sized) by the projection of light emitted from spot array generator 103 onto the surface of specimen 123. In this manner, electromagnetic energy is transferred to specimen 123 over incident spot area 126.

In some embodiments, system 100 may include a deflector (not shown). In one embodiment, the deflector may be an acousto-optical deflector (AOD). In other embodiments, the deflector may include a mechanical scanning assembly, an electronic scanner, a rotating mirror, a polygon based scanner, a resonant scanner, a piezoelectric scanner, a galvometer mirror, or a galvanometer. The deflector scans the light beam over the specimen. In some embodiments, the deflector may scan the light beam over the specimen at an approximately constant scanning speed.

In the illustrated embodiments, specimen positioning system 125 moves specimen 123 while energy is transferred to specimen 123 over the area of electron beam incidence 192 or over the incident spot area 126. In the illustrated embodiments, specimen positioning system 125 includes a chuck 108, motion controller 114, a rotation stage 110 and a translation stage 112. Specimen 123 is supported on chuck 108. Specimen 123 is located with its geometric center 150 approximately aligned with the axis of rotation of rotation stage 110. In this manner, rotation stage 110 spins specimen 123 about its geometric center at a specified angular velocity, ω, within an acceptable tolerance. In addition, translation stage 112 translates the specimen 123 in a direction approximately perpendicular to the axis of rotation of rotation stage 110 at a specified velocity, V_{T}. Motion controller 114 coordinates the spinning of specimen 123 by rotation stage 110 and the translation of specimen 123 by translation stage 112 to achieve the desired scanning motion.

In some other embodiments, specimen positioning system 125 may generate motion of specimen 123 by coordinating two translational movements. For example, specimen positioning system 125 may generate motion along two orthogonal, linear axes (e.g., X-Y motion). In such embodiments, system 100 may “paint” linear stripes of energy across the surface of specimen 123.

In some other embodiments, a number of specimens may be arranged on a large platter with a geometric center that is approximately aligned with the axis of rotation of rotation stage 110. In this manner, rotation stage 110 spins the platter holding a number of specimens at a specified angular velocity, ω, within an acceptable tolerance. In addition, a translation stage 112 translates the platter in a direction approximately perpendicular to the axis of rotation of rotation stage 110 at a specified velocity, V_{T}. Motion controller 114 coordinates the spinning of the platter by rotation stage 110 and the translation of the platter by translation stage 112. In such embodiments, system 100 “paints” arc shaped stripes of energy across the surface of specimen 123.

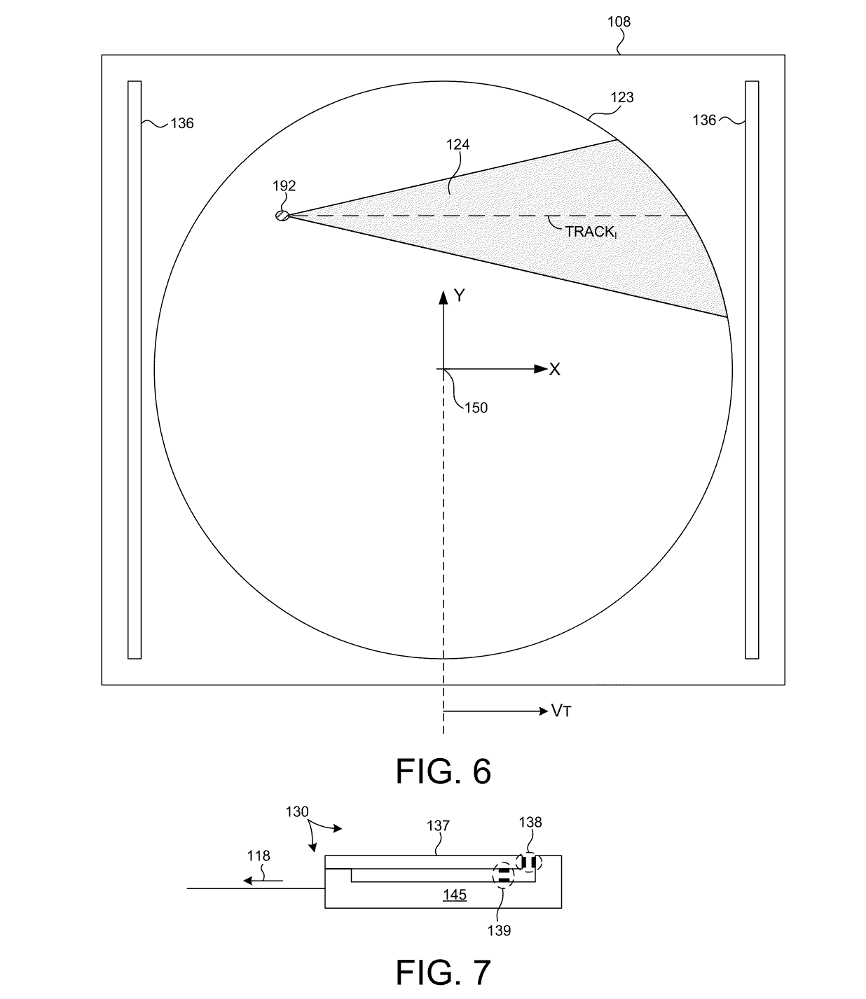

In some examples of lithography systems based on scanning electron beams, energy may be delivered to the specimen at a rate of approximately 275 milliwatts. In some other examples, beam current of one to three microamperes at 100,000 eV are reflected from DPG 195. For pattern fill geometry up to 50% (e.g., lines and spaces), the power delivered to the wafer may be up to 150 milliwatts. Over time, the heat generated dissipates through the specimen and causes changes in dimension of the specimen. FIG. 6 illustrates a specimen 123 attached to a chuck 108. An area of electron beam incidence 192 is projected onto the surface of specimen 123. As the specimen 123 is scanned in the x-direction at velocity, V_{T}, a stripe of heat is effectively painted across the surface of specimen 123 along the path traversed by an area of electron beam incidence 192 (e.g., trackᵢ illustrated in FIG. 6). The heat dissipates across the specimen 123 over time. As time passes, the heat spreads farther away from the locus of areas of electron beam incidence 192 located along trackᵢ. Hence, as illustrated in FIG. 6, a plume of heat 124 forms behind the path traversed by the area of electron beam incidence 192. In some examples, the heat spreads across a zone of approximately 100 millimeters in the time it takes for one pass across the surface of specimen 123 at a scan velocity of approximately one meter/second. Moreover, a dimensional change of specimen 123 of approximately one nanometer may result from the heat introduced in this single pass. Without a mechanism to remove heat from specimen 123, the accumulated heat from many passes results in dimensional changes that substantially exceed the requirements for stitching and overlay accuracy of modern lithographic systems.

In one aspect, semiconductor processing system 100 implements heat control functionality that precisely balances the amount of heat introduced by exposure of a specimen to process energy to an amount of heat removed from the specimen. During processing, an amount of heat is generated by an interaction between the specimen and the amount of energy projected onto the specimen surface. The heat introduced into the specimen is rapidly removed by a cooling element. A heating element disposed between the specimen and the cooling element is controlled to precisely regulate the amount heat removed from the specimen. Control of the heating element is based on the dosage of energy known apriori and may also be based on sensor feedback indicative of the temperature of the specimen.

FIGS. 1 and 9 illustrate embodiments of a semiconductor processing system 100 that precisely balance the amount of heat removed from a specimen with the amount of heat introduced by exposure of the specimen to process energy. System 100 includes a cooling element 106 disposed above the surface of specimen 123 and at least one heating element disposed between cooling element 106 and specimen 123. As illustrated in FIGS. 1 and 9, an array of individually addressable heating elements 105 may be employed.

In some embodiments, cooling element 106 is a plate maintained at a constant, low temperature by a cryogenic cooling system 107. In one embodiment, cryogenic cooling system 107 may supply liquid nitrogen through an insulated supply line 116 to cooling plate 106 to maintain the plate at a constant temperature. As the cooling plate 106 absorbs heat from specimen 123, the liquid nitrogen is slowly boiled away at atmospheric pressure and returned to cryogenic cooling system 107. The temperature of cooling plate 106 is maintained at 77 Kelvin (the boiling point of nitrogen at atmospheric pressure) by maintaining a constant supply of liquid nitrogen to replace that which has boiled away. Although cryogenic cooling system 107 may employ nitrogen as the working fluid, many other working fluids may be contemplated (e.g., argon, helium, etc.). In some other embodiments, thermoelectric cooling systems (e.g., Peltier cooler) or a cryogenic pump may be employed.

In addition to cooling plate 106, at least one heating element is located between cooling plate 106 and specimen 123. As depicted, an array of heating elements 105 is located between cooling plate 106 and specimen 123. Each heating element of the array may be individually addressable and controllable. By way of example, each heating element may be an individually addressable, thin film resistor or a resistive wire heater. The array of heating elements 105 is constructed in a thin layer that is substantially thermally transparent. In this manner, the presence of the array of heating elements 105 between specimen 123 and cooling element 106 does not substantially impact the heat flow from specimen 123 to cooling element 106. Each of the array of heating elements 105 are operable to reach temperatures that are greater than the temperature of specimen 123 (e.g., greater than room temperature). In this manner, each of the array of heating elements 105 can radioactively transfer heat to specimen 123.

During processing by system 100, it may be desirable to maintain the specimen 123 at room temperature (e.g., 298 Kelvin). The substantial difference in temperature between cooling element 106 (e.g., 77 Kelvin) and specimen 123 (e.g., 298 Kelvin) causes a significant radiative transfer of heat between specimen 123 and cooling element 106. Many semiconductor processes, including electron beam lithography and inspection, must be performed in vacuum. Radiative heat transfer from the top surface of specimen 123 is well suited for cooling of specimen 123 in a vacuum environment without contacting the delicate wafer surface.

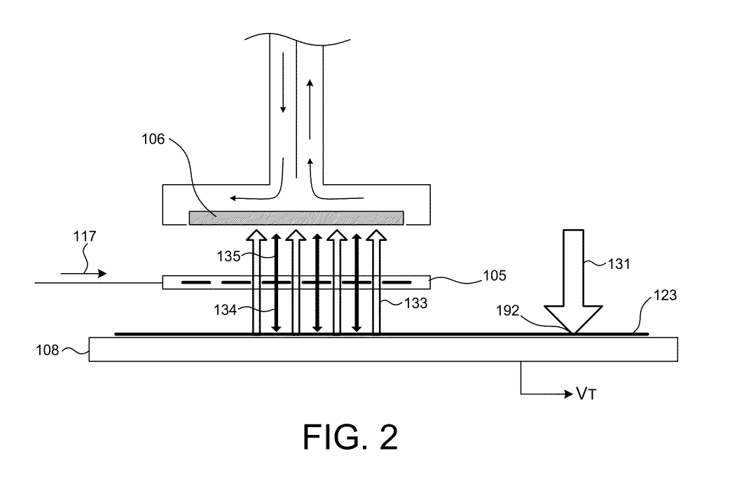

FIG. 2 illustrates a radiative heat flow 133 from specimen 123 to cooling element 106, a radiative heat flow 134 from the array of heating elements 105 to specimen 123, and a radiative heat flow 135 from the array of heating elements 105 to cooling element 106. Radiative heat flow 133 is determined by the difference in temperature between specimen 123 and cooling element 106 and the area of cooling element 106 exposed to specimen 123. For a given area of cooling element 106 exposed to specimen 123 and constant temperatures of cooling element 106 and specimen 123, heat flow 133 is a constant value. For example, for an exposed area of 1,500 mm², wafer emissivity of 0.6, cooling plate emissivity of 0.8, cooling plate temperature of 77 Kelvin, and wafer temperature of 298 Kelvin, heat flow 133 is approximately 389 milliwatts. Radiative heat flow 135 represents undesirable heat flow to cooling element 106. This may be minimized by including a reflector layer between each heating element and cooling element 106. For example, a layer of gold may be placed adjacent to resistive traces of heating element 105. In this manner, heat generated by heating element toward cooling element 106 is reflected away and down toward specimen 123.

As illustrated in FIG. 2, an area of incident process energy (e.g., area of electron beam incidence 192, or alternatively, incident spot area 126) projected onto the surface of specimen 123 effectively introduces a heat flow 131 into specimen 123. The magnitude of heat flow 131 depends on many factors including the feature density of the pattern being printed on specimen 123. In one example, the feature density can vary between 6% and 50% over the surface of a specimen 123. Thus, heat flow 131 may vary substantially depending on the location of incident spot 126 on specimen 123. As a result the amount of heat that must be removed from specimen 123 may vary substantially.

In general, the exposure area of cooling element 106 and the temperature of cooling element 106 are selected such that the heat flow 133 from specimen 123 to cooling element 106 exceeds the maximum expected heat flow 131 introduced to specimen 123 by incident process energy. Because of this imbalance, specimen 123 would gradually be cooled far below room temperature if not for heat introduced to specimen 123 by the array of heating elements 105. To compensate for the difference between the varying heat flow 131 into specimen 123 and the constant heat flow 133 out of specimen 123, the array of heating elements 105 are controlled to generate a radiative heat flow 134 into specimen 123 such that the total amount of heat introduced into specimen 123 by incident process energy and the array of heating elements 105 balances with the amount of heat removed from specimen 123 by cooling element 106.

In embodiments that employ a cooling element chilled by a cryogenic fluid (e.g., liquid nitrogen), the temperature of the cooling element 106 is determined by the boiling point of the working fluid, and thus is effectively fixed. However, in other embodiments a cooling element may be selected that allows for a controllable cryogenic temperature (e.g., a thermoelectric cooler). In these embodiments, the temperature of cooling element 106 may be determined such that the amount of heat added by the array of heating elements 105 is minimized, and in some cases eliminated completely.

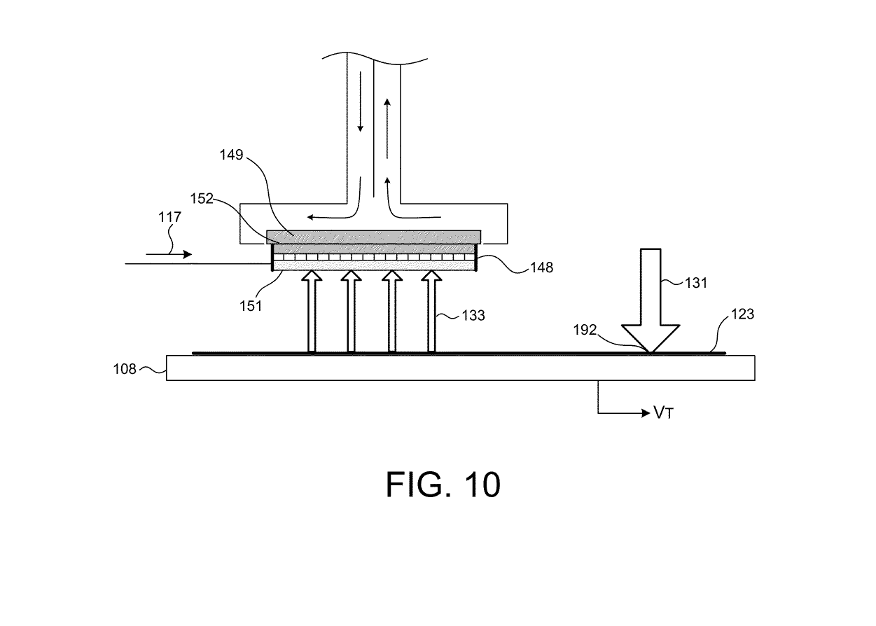

By way of example, FIG. 10 illustrates a thermoelectric cooler 148 spaced apart from specimen 123 and located on the same side of specimen 123 upon which process energy is projected. Thermoelectric cooler 148 transports heat (e.g., heat flow 133) absorbed from specimen 123 at surface 151 across to surface 152 that is in contact with a heat sink 149. Heat sink 149 operates simply to transport excess heat away from surface 152. Thermoelectric cooler 148 (e.g., a Peltier cooler) is able to controllably transport heat from surface 151 to surface 152 based on control signal 117 received from controller 132. In this manner, the amount of heat removed from specimen 123 may be controlled directly by operation of thermoelectric cooler 148 without the need for a heating element.

Referring again to FIG. 1, system 100 includes sensors 120A and 120B. Sensors 120A and 120B generate output signals 118A and 118B, respectively. Signals 118A and 118B are indicative of the temperature of specimen 123 at the locations of specimen 123 in view of sensors 120A and 120B, respectively. By way of example, sensors 120A and 120B may be infrared detectors sensitive to thermal energy emitted from a specimen surface at room temperature. Assuming a specimen surface resembles a black body radiator at room temperature, the peak emission wavelength at room temperature is approximately ten micrometers based on Wien's Law. Thus, an infrared detector sensitive to a wavelength range around ten micrometers would be suitable. By way of example, infrared detector module, model number P7752, manufactured by Hamamatsu, K. K. (Japan) may be suitable. In other embodiments, sensors 120A and 120B may be bolometers.

Sensors 120A and 120B are fixed with respect to the projection subsystem and the cooling element 106 and face specimen 123. Sensor 120A is positioned to view the surface of specimen 123 before it is subjected to incident process energy. Thus, output signal 118A is indicative of the temperature of the surface of specimen 123 before it is subjected to process energy. Sensor 120B is positioned to view the surface of specimen 123 after heat removal. Thus, output signal 118B is indicative of the temperature of the surface of specimen 123 after heat has been removed by cooling element 106. In this manner, a difference between output signals 118A and 118B is indicative of whether the heat removed from specimen 123 is balanced with the heat added to specimen 123 by the incident process energy.

System 100 includes a heat balancing controller 132 that includes a processor 141 and an amount of computer readable memory 142. Processor 141 and memory 142 may communicate over bus 143. Memory 142 includes an amount of memory 144 that stores a program code that, when executed by processor 141, causes processor 141 to adjust a temperature of at least one heating element such that an amount of heat removed from specimen 123 is approximately equal to the amount of heat introduced to the specimen by incident process energy.

In one example, controller 132 receives an indication of the energy dosage to the specimen 123 and generates a control signal 117 based on the energy dosage. For example, as illustrated in FIG. 1, controller 132 may receive a signal 122 from the projection subsystem (e.g., projection subsystems 129 or 190) that indicates the process energy directed to the specimen 123 at a given time. In response, controller 132 generates a control signal 117 that indicates a desired temperature of a particular heating element of the array of heating elements 105 based on the energy dosage. Alternatively, controller 132 generates a control signal 117 that indicates a desired current flow through a particular heating element based on the energy dosage. The desired current flow is determined to supply enough heat to specimen 123 to compensate for the difference between heat removed from specimen 123 by cooling element 106 and heat added to specimen 123 by the incident process energy.

The determination of control signal 117 based on energy dosage is a form of feedforward control. In other words, the determination of the desired temperature or current flow of a heating element is based on assumptions of the amount of heat actually generated in the specimen 123 by interaction with incident process energy and the amount of heat actually removed from specimen 123 by cooling element 106. These actual values depend on the emissivity of the specimen surface and the cooling surface, the temperature of the specimen and cooling surfaces, etc. As such, controller 132 may generate control signal 117 using a model that captures the effects of resist properties, pattern properties, the geometry of the specimen, etc. As long as the actual values are accurately estimated, the desired temperature of current flow of a heating element can be accurately determined.

In some other examples, controller 132 also generates control signal 117 based on an indication of the temperature of specimen 123 to further improve heat control accuracy. The determination of control signal 117 based on an indication of the temperature of specimen 123 is a form of feedback control. In other words, the control signal is determined based on a comparison between a measured quantity (e.g., temperature) and a predetermined reference value. In one example, controller 132 receives signals 118A and 118B from sensors 120A and 120B, respectively. These signals are indicative of specimen temperature before energy dosage and after heat removal. Controller 132 generates a control signal 117 based on the difference between signals 118A and 118B. The control objective is to control the heat introduced to specimen 123 by the array of heating elements 105 such that the difference between signals 118A and 118B is zero. In this manner, the difference between the heat added to specimen 123 by process energy and the net amount of heat removed from specimen 123 by cooling element 106 and the array of heating elements 105 is driven toward zero.

Although, control signal 117 may be determined to drive the difference between signals 118A and 118B toward zero, any residual heating or excess cooling of the specimen will cause the temperature of specimen 123 to drift over time. To reduce the impact of temperature drift of specimen 123, control signal 117 may also be determined based on an absolute indication of temperature of specimen 123.

In one example, illustrated in FIG. 6, an array of temperature sensors 136 may be mounted on chuck 108 adjacent to specimen 123. For example, the array of temperature sensors 136 may be a SenseArray Process Probe™ manufactured by KLA-Tencor, Corporation (USA). The array of temperature sensors 136 is subjected to incident process energy and is cooled by the controlled action of cooling element 106 and the array of heating elements 105. Residual heat or excess cooling of a temperature sensor results in a deviation from the desired process temperature. In response, controller 132 generates a control signal 117 based on the difference between the temperature measured by the array of temperature sensors 136 and a desired process temperature. The control objective is to control the heat introduced to specimen 123 by the array of heating elements 105 such that the difference between the temperature sensed by the array of temperature sensors 136 and a desired process temperature is zero.

In another example, the indication of temperature of specimen 123 may be sensed by a dilatometer. In one example, illustrated in FIG. 7, a dilatometer 130 includes a specimen 137 mounted on one end to a Zerodur® frame 145. As the specimen 137 is subjected to process energy and heat removal, any residual heat or excess cooling of the specimen 137 results in a change in dimension of specimen 137. The Zerodur® frame provides a dimensionally stable measurement reference due to its extremely small coefficient of thermal expansion. In this manner, the change of dimension of specimen 137 can be accurately measured by capacitive probes 138 and 139. The change of dimension of specimen 137 is used as a proxy for a change in temperature of specimen 123. In this example, controller 132 generates a control signal 117 based on a signal 118 indicative of a change in dimension of specimen 137. The control objective is to control the heat introduced to specimen 123 by the array of heating elements 105 such that the dimension of specimen 137 sensed by dilatometer 130 remains at a stable reference value.

In some examples, specimen 137 may be selected to be the same material composition as specimen 123. In this manner, the differences in emissivity between specimen 137 and 123 are minimized. In another example, specimen 137 may be a SenseArray Process Probe™. In this manner, dilatometer 130 may generate both a signal indicative of temperature and a signal indicative of dimension of specimen 137. In some embodiments a number of dilatometers 130 may be arranged on chuck 108 such that specimen 137 is subjected to process energy on each pass of specimen 123.

In another example, control signal 117 may be determined based on sensors used to measure movements and spatial distortions of a wafer during process. In these embodiments, signals indicative of a change in temperature of specimen 123 are based on the spatial distortions detected by alignment sensors of system 100. For example, in many semiconductor processes, particularly lithography, relative movements of alignment marks present on a specimen are monitored during process to determine changes in shape or movements of the specimen. Typically, a grating pattern printed on the specimen is monitored by a sensor and compared to a reference grating. The sensor detects phase shifts between the gratings to determine movement of the specimen. Movement of the specimen typically results from changes in temperature of the specimen. In this manner, changes in alignment sensor output are indicative of whether the heat removed from specimen 123 is balanced with the heat added to specimen 123 by the incident process energy. Examples of wafer positioning sensors and systems are illustrated in U.S. Pat. No. 7,068,833 to Ghinovker et al., which is incorporated by reference as if fully set forth herein.

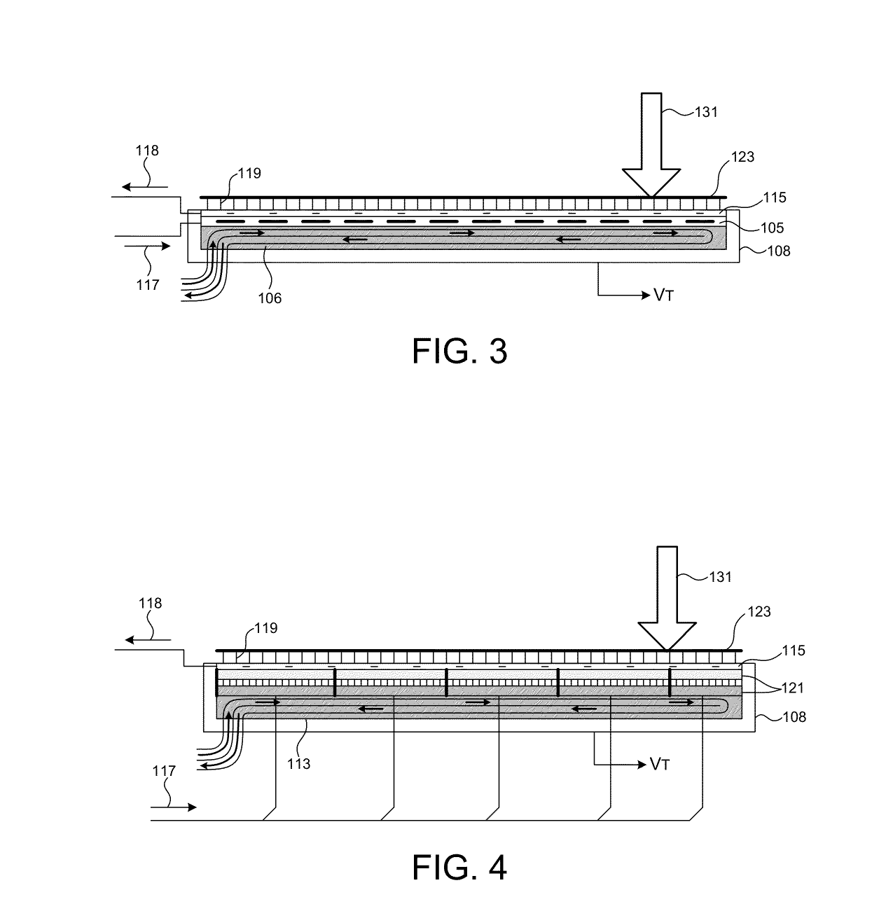

In another embodiment, illustrated in FIG. 3, chuck 108 includes an array of cooling elements 106 mounted below the backside of specimen 123 (e.g., cooling channels arranged in a number of different zones), an array of heating elements 105 mounted between the cooling element 106 and specimen 123, and an array of temperature sensors 115 mounted between the array of heating elements 105 and specimen 123. The array of temperature sensors 115 provides a measurement of the temperature field on the back side of specimen 123. Residual heat or excess cooling of a portion of specimen 123 is detected by a temperature sensor located beneath that portion of the specimen 123. In one example, the array of temperature sensors 136 may be a SenseArray Process Probe™ manufactured by KLA-Tencor, Corporation (USA). A signal 118 is received by controller 132 that indicates the temperature field on the backside of specimen 123. In response, controller 132 generates a control signal 117 based on the difference between the temperature field measured by the array of temperature sensors 115 and a desired temperature field. The control objective is to control the heat introduced to specimen 123 by the array of heating elements 105 such that the difference between the temperature field sensed by the array of temperature sensors 115 and a desired temperature field is zero. In response to control signal 117, the array of heating elements 105 generate heat at the desired locations on the backside of specimen 123.

In the depicted embodiments, controller 132 includes processor 141 and memory 142 and implements heat removal control functionality of a semiconductor processing system in accordance with the methods described herein. However, in other embodiments, heat removal control functionality may be implemented by any other general purpose computer or dedicated hardware of semiconductor processing system 100 configured to operate in an analogous manner.

As depicted in FIGS. 1 and 2, heat is removed from specimen 123 after its introduction. However, in other embodiments, heat may be removed from specimen 123 before its introduction. For example, a portion of specimen 123 may be chilled by combined action of cooling element 106 and the array of heating elements 105, and then heated to room temperature by process energy. In some other embodiments, heat may be removed from specimen 123 both before and after its introduction by process energy.

As depicted in FIGS. 1 and 2, cooling element 106 and the array of heating elements 105 are separated from the structure that delivers energy to specimen 123. However, in some embodiments, cooling element 106 and the array of heating elements 105 may be located on a surface of the projection system (e.g., projection system 129 or 190) facing the surface of specimen 123. In this manner, heat may be removed from specimen 123 almost immediately after its introduction and dissipation of heat over a large area of the specimen is minimized. At the point in time when heat is generated on the wafer surface, the temperature over the area of heat generation is at its peak. Hence, the temperature difference between this area and cooling element 106 is at its largest and radiative heat transfer is most effective. Over time, as the heat dissipates over the wafer surface, the temperature peak moderates and radiative heat transfer becomes less effective. However, careful design consideration must be taken to avoid introducing inaccuracy into the system metrology by heating or cooling elements of the projection subsystem.

As depicted in FIGS. 1 and 2, cooling element 106 and the array of heating elements 105 are located on the same side of the specimen surface under process (i.e., front side of the specimen). However, in some embodiments, cooling element 106 and the array of heating elements 105 may be located on the opposite side of the specimen surface under process (i.e., back side of the specimen). In the embodiment depicted in FIG. 3, cooling element 106 is built into chuck 108 and the array of heating elements 105 is located between cooling element 106 and specimen 123. In addition, specimen 123 is in direct thermal contact with the chuck 108 via pins 119. Thus, heat transfer from specimen 123 is augmented by conduction.

Heat flow via conduction is limited by the small surface area of pins 119 in direct contact with specimen 123. In some embodiments, a seal may be made between the perimeter of the specimen 123 and the chuck such that a thermally conducive fluid (e.g., helium) may be introduced between the backside of the specimen 123 and the specimen 123. Thus, heat transfer from specimen 123 by conduction and convection may occur. In this manner, heat transfer from specimen 123 to cooling element 106 and from the array of heating elements 105 to specimen 123 relies more heavily on conduction and convection rather than energy.

In another aspect, an array of cooling elements is directly controlled to precisely regulate the amount heat removed from the specimen. Control of the array of cooling elements is based on the dosage of process energy. In some examples, control of the array of cooling elements is also based on sensor feedback indicative of the temperature of the specimen.

In the embodiment depicted in FIG. 4, chuck 108 includes an array of cooling elements 121 mounted below the backside of specimen 123 and an array of temperature sensors 115 mounted between the array of cooling elements 121 and specimen 123. In one example, the array of cooling elements is an array of individually addressable and controllable thermoelectric coolers. The array of temperature sensors 115 provides a measurement of the temperature field on the back side of specimen 123. Residual heat or excess cooling of a portion of specimen 123 is detected by a temperature sensor located beneath that portion of the specimen 123. In one example, the array of temperature sensors 136 may be a SenseArray Process Probe™ manufactured by KLA-Tencor, Corporation (USA). A signal 118 is received by controller 132 that indicates the temperature field on the backside of specimen 123. In response, controller 132 generates a control signal 117 based on the difference between the temperature field measured by the array of temperature sensors 115 and a desired temperature field. The control objective is to control the heat absorbed from specimen 123 by the array of cooling elements 121 such that the difference between the temperature field sensed by the array of temperature sensors 115 and a desired temperature field is zero. In response to control signal 117, the array of cooling elements 121 selectively absorbs heat from the backside of specimen 123 at the desired locations. Heat generated by the thermoelectric cooler 121 is removed from chuck 108 by a radiator 113.

In another aspect, the amount of surface area of the cooling element 106 exposed to the specimen 123 is controlled by an adjustable aperture. In this manner, the amount of heat removed from the specimen is controlled by adjusting the size of the aperture.

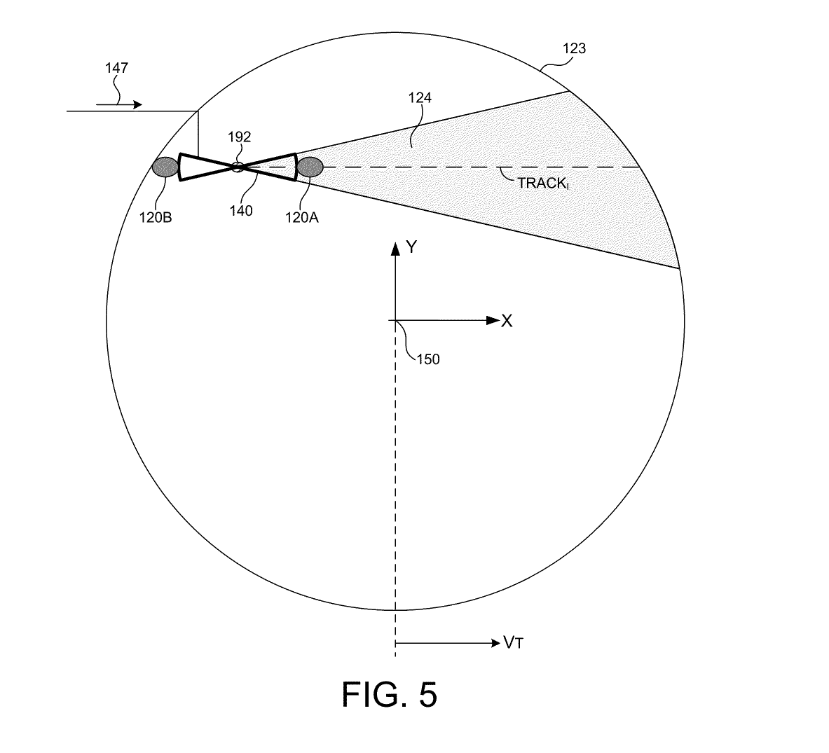

In the embodiment depicted in FIG. 5, an adjustable aperture 140 is located between specimen 123 and cooling plate 106. In one embodiment, the surfaces of adjustable aperture 140 that face specimen 123 are gold plated to minimize absorption of heat from specimen 123 by the structure of adjustable aperture 140. In this manner, the absorption of heat from specimen 123 is primarily focused over the area of cooling element 106 that is exposed to specimen 123. The area of exposure of cooling element 106 is determined by adjustable aperture 140. In some embodiments, adjustable aperture 140 may include a thin sheet member akin to a sliding door or a camera shutter that is moved by an actuator (e.g., a piezo actuator) to selectively increase or decrease the area of cooling element 106 exposed to specimen 123.

In some embodiments, the shape of adjustable aperture 140 is designed to approximately match the shape of the heat plume 124 expected under operating conditions. In this manner, the spatial distribution of heat absorbed from specimen 123 approximately matches the spatial distribution of heat introduced into specimen 123. In this manner, local distortions of specimen 123 are minimized.

In one example, the area of cooling element 106 exposed to specimen 123 is adjusted to keep the amount of heat absorbed by cooling element 106 closely matched to the heat introduced to specimen 123 by the process energy. In this manner, the amount of heat generation required from the array of heating elements 105 is minimized or eliminated. This minimizes the overall amount of heat that must be removed by cryogenic cooling system 107. In this example, controller 132 generates a control signal 147 that is transmitted to adjustable aperture 140 to change the area of cooling element 106 exposed to specimen 123 based on the magnitude of control signal 117 communicated to the array of heating elements 107. For example, if the magnitude of control signal 117 communicated to the array of heating elements exceeds a predetermined threshold value, controller 132 commands adjustable aperture 140 to reduce the amount of exposed area. Conversely, if the magnitude of control signal 117 falls below a different predetermined threshold value, controller 132 commands adjustable aperture 140 to increase the amount of exposed area.

In some examples, control of the amount of heat removed from specimen 123 is based entirely on controlling the area of cooling element 106 exposed to specimen 123. In these examples, controller 132 generates control signal 147 based on the amount of process energy directed to specimen 123 and may also be based on an indication of the temperature of specimen 123 as discussed hereinbefore.

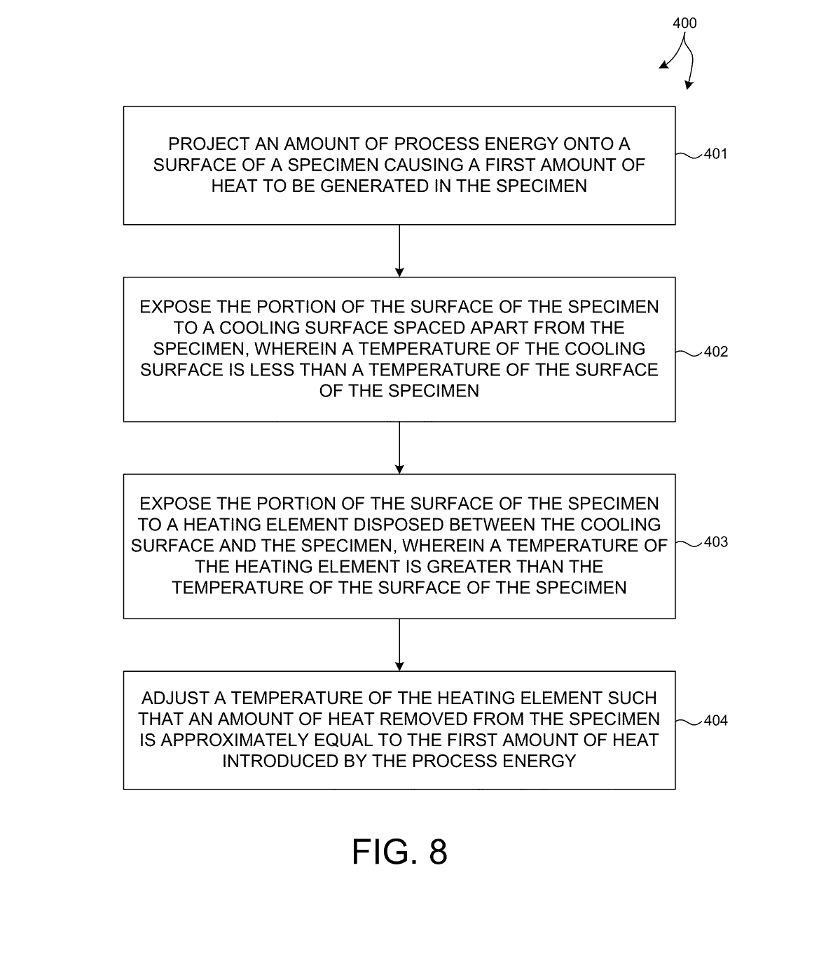

FIG. 8 illustrates a flowchart of an exemplary method 400 useful for balancing a heat load introduced into a specimen with an amount of heat removal. By way of non-limiting example, method 400 is described with reference to the embodiment illustrated in FIG. 1 for explanatory purposes.

In block 401, a projection subsystem 190 projects an amount of process energy onto a portion of a surface of a specimen. The incident process energy causes an amount of heat to be generated within the specimen.

In block 402, the portion of the surface of the specimen is exposed to a cooling element 106 that is spaced apart from the specimen. The temperature of the cooling element 106 is maintained at a temperature that is lower than the temperature of the surface of the specimen.

In block 403, the portion of the surface of the specimen is also exposed to a heating element 105 disposed between the cooling element 106 and the specimen. The temperature of the heating element is greater than the temperature of the surface of the specimen.

In block 404, the temperature of the heating element is adjusted such that the amount of heat removed from the specimen is approximately equal to the amount of heat introduced to the specimen by the incident process energy.

Various embodiments are described herein for a semiconductor processing system (e.g., an inspection system or a lithography system) that may be used for processing a specimen. The term “specimen” is used herein to refer to a wafer, a reticle, or any other sample that may be processed (e.g., printed or inspected for defects) by means known in the art.

As used herein, the term “wafer” generally refers to substrates formed of a semiconductor or non-semiconductor material. Examples include, but are not limited to, monocrystalline silicon, gallium arsenide, and indium phosphide. Such substrates may be commonly found and/or processed in semiconductor fabrication facilities. In some cases, a wafer may include only the substrate (i.e., bare wafer). Alternatively, a wafer may include one or more layers of different materials formed upon a substrate. One or more layers formed on a wafer may be “patterned” or “unpatterned.” For example, a wafer may include a plurality of dies having repeatable pattern features.

A “reticle” may be a reticle at any stage of a reticle fabrication process, or a completed reticle that may or may not be released for use in a semiconductor fabrication facility. A reticle, or a “mask,” is generally defined as a substantially transparent substrate having substantially opaque regions formed thereon and configured in a pattern. The substrate may include, for example, a glass material such as quartz. A reticle may be disposed above a resist-covered wafer during an exposure step of a lithography process such that the pattern on the reticle may be transferred to the resist.

One or more layers formed on a wafer may be patterned or unpatterned. For example, a wafer may include a plurality of dies, each having repeatable pattern features. Formation and processing of such layers of material may ultimately result in completed devices. Many different types of devices may be formed on a wafer, and the term wafer as used herein is intended to encompass a wafer on which any type of device known in the art is being fabricated.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although certain specific embodiments are described above for instructional purposes, the teachings of this patent document have general applicability and are not limited to the specific embodiments described above. Accordingly, various modifications, adaptations, and combinations of various features of the described embodiments can be practiced without departing from the scope of the invention as set forth in the claims.

What is claimed is:

1. An apparatus comprising:
a projection subsystem configured to project an amount of process energy onto a surface of a specimen that generates a first amount of heat in the specimen;
a cooling element disposed adjacent to a surface of the specimen, the cooling element configured to absorb a second amount of heat from the specimen that is greater than the first amount of heat;
at least one individually addressable heating element disposed between the specimen and the cooling element, the at least one heating element configured to generate an amount of heat in response to a control signal; and
a controller operable to generate the control signal such that the at least one heating element generates a third amount of heat projected to the surface of the specimen, wherein the third amount of heat is approximately equal to a difference between the second amount of heat and the first amount of heat.

2. The apparatus of claim 1, wherein the control signal is based at least in part on an indication of the amount of energy.

3. The apparatus of claim 2, further comprising:
a sensor operable to generate a signal indicative of a temperature of the specimen, wherein the controller is operable to generate the control signal based at least in part on the temperature of the specimen.

4. The apparatus of claim 1, wherein the at least one heating element is one of an array of heating elements that includes a plurality of resistive heating elements arranged in a plurality of zones adjacent to the surface of the specimen.

5. The apparatus of claim 1, wherein the cooling element is any of a thermoelectric cooler, a chilled plate structure, and a cyrogenic cooler.

6. The apparatus of claim 1, wherein the cooling element is disposed on the same side of the surface of the specimen subject to the energy.

7. The apparatus of claim 1, wherein the cooling element is disposed on a side of the specimen opposite the surface of the specimen subject to the energy.

8. The apparatus of claim 1, further comprising an adjustable aperture that selectively adjusts an area of a surface of the cooling element exposed to the specimen.

9. The apparatus of claim 8, wherein the controller is also operable to generate a command signal to adjust the area of the surface of the cooling element exposed to the specimen.

10. The apparatus of claim 1, wherein the controller is also operable to generate a command signal to change a temperature of the cooling element.

11. The apparatus of claim 1, wherein the sensor is a temperature sensor.

12. The apparatus of claim 1, wherein the sensor is a displacement sensor that generates a signal indicative of a change in size of the specimen.

13. A method comprising:
projecting an amount of process energy onto a portion of a surface of a specimen, the amount of energy causing a first amount of heat to be generated in the specimen;
exposing the portion of the surface of the specimen to a cooling element spaced apart from the specimen, wherein a temperature of the cooling element is less than a temperature of the surface of the specimen;
exposing the portion of the surface of the specimen to a heating element disposed between the cooling surface and the specimen, wherein a temperature of the heating element is greater than the temperature of the surface of the specimen; and
adjusting the temperature of the heating element such that an amount of heat removed from the specimen is approximately equal to the first amount of heat.

14. The method of claim 13, wherein the adjusting of the temperature of the heating element is based at least in part on an indication of the amount of energy.

15. The method of claim 14, wherein the adjusting of the temperature of the heating element is based at least in part on an indication of a temperature of the specimen.

16. The method of claim 13, wherein the heating element is one of an array of individually addressable, resistive heating elements disposed between the surface of the specimen and the cooling element.

17. The method of claim 13, further comprising:
selectively adjusting a size of an aperture that defines an area of the surface of the cooling element exposed to the specimen.

18. The method of claim 17, wherein the adjusting of the size of the aperture involves generating a command signal based at least in part on the temperature of the heating element and communicating the command signal to an adjustable aperture mechanism.

19. An apparatus comprising:
a processor; and
a non-transitory, computer-readable medium storing instructions that, when executed by the processor, cause the apparatus to:
receive a signal indicative of an amount of energy projected onto a portion of a surface of a specimen, the amount of energy causing a first amount of heat to be generated in the specimen;
determine a control signal such that at least one heating element generates a second amount of heat projected to the surface of the specimen, wherein the second amount of heat is approximately equal to a difference between a third amount of heat absorbed from the specimen by a cooling element and the first amount of heat; and
communicate the control signal to the at least one heating element.

20. The apparatus of claim 19, wherein the instructions further comprise instructions that, when executed by the processor, cause the apparatus to:
receive a signal indicative of a temperature of the specimen; and
determine the control signal based at least in part on the signal indicative of the amount of energy projected onto the portion of a surface of a specimen and the signal indicative of the temperature of the specimen.

21. An apparatus comprising:
a projection subsystem configured to project an amount of process energy onto a surface of a specimen that generates a first amount of heat in the specimen;
at least one cooling element disposed adjacent to and spaced apart from the surface of the specimen subject to the amount of process energy, wherein the cooling element is configured to absorb an amount of heat from the specimen by radiative heat transfer; and
a controller operable to generate a control signal communicated to the cooling element to adjust a temperature of the cooling element such the amount of heat absorbed from the specimen by the cooling element is approximately equal to the first amount of heat.

22. The apparatus of claim 21, wherein the control signal is based at least in part on an indication of the amount of process energy.

23. The apparatus of claim 22, further comprising:
a sensor operable to generate a signal indicative of a temperature of the specimen, wherein the controller is operable to generate the control signal based at least in part on the temperature of the specimen.
